(19) United States
(12) Patent Application Publication
(10) Pub. No.: US 2026/0104619 A1
(43) Pub. Date: Apr. 16, 2026

(54) OPTICAL MODULATOR AND OPTICAL TRANSMISSION SYSTEM WITH NEGATIVE CHIRP BASED ON DIFFERENTIAL SIGNAL

(71) Applicant: Global Technology Inc., Ningbo (CN)

(72) Inventors: Weikang KE, Ningbo (CN); Fan YANG, Ningbo (CN); Qikun Huang, Ningbo (CN)

(21) Appl. No.: 18/986,238

(22) Filed: Dec. 18, 2024

(30) Foreign Application Priority Data
Oct. 10, 2024 (CN) 202411410670.0

(51) Int. Cl. G02F 1/225; G02F 1/21; H04B 10/516

(52) U.S. Cl. CPC G02F 1/2255; G02F 1/212; H04B 10/516; G02F 2202/20

(57) ABSTRACT

An optical modulator and optical transmission system. The optical modulator includes a first/second optical waveguide, a first/second radio frequency signal channel and a first/second grounding channel. The second optical waveguide and the first optical waveguide are optically coupled to an optical input end and an optical output end. The first radio frequency signal channel is disposed at one side of the first optical waveguide and is configured to receive a first differential signal. The second radio frequency signal channel is disposed at another side of the first optical waveguide and is configured to receive a second differential signal, wherein the first differential signal and the second differential signal have different phases. The first grounding channel is disposed at one side of the second optical waveguide and is connected to ground. The second grounding channel is disposed at another side of the second optical waveguide and is connected to ground.

### CROSS-REFERENCE TO RELATED APPLICATIONS

This non-provisional application claims priority under 35 U.S. C. § 119(a) on Patent Application No(s). 202411410670.0 filed in China on Oct. 10, 2024, the entire contents of which are hereby incorporated by reference.

### BACKGROUND

### 1. Technical Field

This disclosure relates to an optical modulator and optical transmission system with negative chirp based on differential signal.

### 2. Related Art

The optical module may transmit and/or receive optical signals for applications such as but not limited to the network data center, the cable TV and the fiber to the home (FTTH). Using optical modules for transmission may provide higher transmission rates and signal bandwidth over longer transmission distances. In order to promote the compatibility of global optical Internet products and reduce the maintenance burden, organizations such as the Multi-Source Agreement (MSA), the Institute of Electrical and Electronics Engineers (IEEE), and the Optical Internetworking Forum (OIF) have developed several form factors (Form Factor) suitable for different signal transmission rates. These form factors include but are not limited to XFP, SFP, QSFP (Quad Small Form Factor Pluggable), QSFP-DD (Double Density), OSFP (Octal Small Form Factor Pluggable) and CPO (Co-Packaged Optics).

Existing optical modules faces challenges in optical power, space management, thermal management, insertion loss and manufacturing yield.

### SUMMARY

According to one or more embodiment of this disclosure, an optical modulator includes a first optical waveguide, a second optical waveguide, a first radio frequency signal channel, a second radio frequency signal channel, a first grounding channel and a second grounding channel. The second optical waveguide and the first optical waveguide are optically coupled to an optical input terminal and an optical output terminal. The first radio frequency signal channel is disposed at one side of the first optical waveguide and is configured to receive a first differential signal. The second radio frequency signal channel is disposed at another side of the first optical waveguide and is configured to receive a second differential signal, wherein the first differential signal and the second differential signal have different phases. The first grounding channel is disposed at one side of the second optical waveguide and is connected to ground. The second grounding channel is disposed at another side of the second optical waveguide and is connected to ground.

According to one or more embodiment of this disclosure, an optical transmission system includes a laser emitter, an optical modulator and a driving circuit. The optical modulator includes a first optical waveguide, a second optical waveguide, a first radio frequency signal channel, a second radio frequency signal channel, a first grounding channel and a second grounding channel. The second optical waveguide and the first optical waveguide are optically coupled to an optical input terminal and an optical output terminal, wherein the optical input terminal is optically coupled to the laser emitter. The first radio frequency signal channel is disposed at one side of the first optical waveguide. The second radio frequency signal channel is disposed at another side of the first optical waveguide. The first grounding channel is disposed at one side of the second optical waveguide and is connected to ground. The second grounding channel is disposed at another side of the second optical waveguide and is connected to ground. The driving circuit is electrically connected to the first radio frequency signal channel and the second radio frequency signal channel, and is configured to provide a first differential signal to the first radio frequency signal channel, and provide a second differential signal to the second radio frequency signal channel, wherein the first differential signal and the second differential signal have different phases.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of an optical modulator according to an embodiment of the present disclosure; and

FIG. 2 is a block diagram of an optical transmission system according to an embodiment of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

With the rapid development of emerging technologies such as artificial intelligence, big data, and the Internet of Things, transmission capacity continues to increase, optical communication technology is also developing rapidly, and the demand and requirements for optical modules are also getting higher.

In modern optical fiber communication systems, the signal transmission quality and speed is directly related to the performance of the modulator. In application scenarios such as transmission rates above 25 G or transmission distances above 40 kilometers, the performance of the modulator plays a more important role. Modulators usually have problems such as high modulation voltage and poor integration and miniaturization capabilities, which limit the further development of optical communication systems. Mach-Zehnder Modulator (MZM) is widely used in the field of optical communications because of its simple structure and stable performance.

The modulation method of MZM usually involves adjusting the input amplitude of two arms respectively, so as to achieve negative chirp modulation through the different amplitudes of the modulation amplitude of the two arms. A modulation method known to the inventor is to input differential signals to both arms of the MZM respectively, but this modulation method cannot realize the function of independent adjustment of positive/negative (P/N) signals, which greatly limits the negative chirp modulation of conventional drives. In addition, in order to input differential signals to the two arms of the MZM, the optical module including the MZM needs to be equipped with at least two laser drivers (LDD), resulting in excessive power consumption of the optical module.

On the other hand, due to material characteristics, MZM may have a high characteristic voltage (Vpi, the voltage that causes the optical signal to produce a phase difference of π), thus requiring a relatively large input amplitude to ensure the performance of MZM modulated optical signals. However, large input amplitudes may cause crosstalk problems in communication systems that are difficult to handle. Therefore, how to achieve negative chirp modulation with a smaller input amplitude while maintaining high-speed modulation is still an important and difficult issue for current research.

According to one or more embodiment of the present disclosure, the optical modulator and optical transmission system, in terms of configuration, the two radio frequency signal channels are disposed at one arm of the optical modulator and the two grounding channels are disposed at another arm thereof, and the two differential signals with different phases are applied to the two radio frequency signal channels respectively, thereby forming a single-arm small amplitude modulation structure. In this way, compared with the traditional dual-arm modulation, the signal amplitude required for modulation may be effectively reduced and the signal crosstalk problem caused by the large amplitude modulation signal may be avoided, and the transmission efficiency and stability of optical signals are also improved. The present disclosure is particularly applicable for high-speed as well as long-distance optical fiber communication systems.

Those with ordinary knowledge in the art may reasonably combine and configure the technical features disclosed herein to achieve corresponding technical effects.

The term “coupling” or “coupled” refers to any connection, link, or similar relationship, and “optical coupling” or “optical coupled” refers to the relationship in which light is transmitted (impart) from one element to another element. Unless otherwise stated, elements that are coupled or coupling to each other do not have to be directly connected to each other and may be separated by intervening elements.

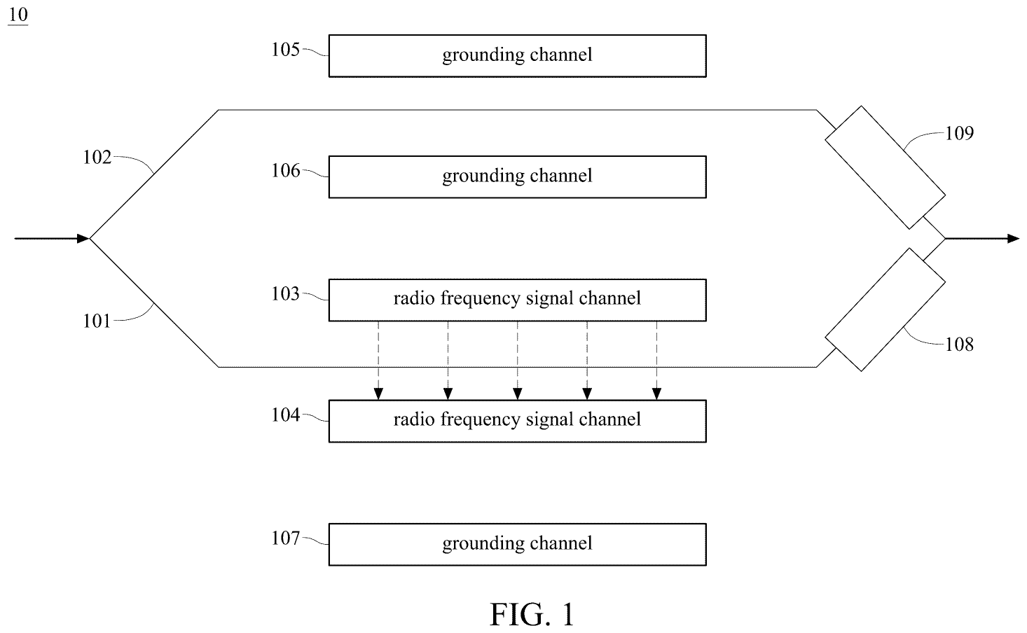

Please refer to FIG. 1 which is a block diagram of an optical modulator according to an embodiment of the present disclosure. As shown in FIG. 1, an optical modulator 10 may include a first optical waveguide 101, a second optical waveguide 102, a first radio frequency signal channel 103, a second radio frequency signal channel 104, a first grounding channel 105 and a second grounding channel 106. In one embodiment, the optical modulator 10 is in a form of dual-arm structure. The second optical waveguide 102 and the first optical waveguide 101 are optically coupled to an optical input terminal and an optical output terminal. The first radio frequency signal channel 103 is disposed at one side of the first optical waveguide 101 and is configured to receive a first differential signal. The second radio frequency signal channel 104 is disposed at the other side of the first optical waveguide 101 and is configured to receive a second differential signal, wherein the first differential signal and the second differential signal have different phases. The first grounding channel 105 is disposed at one side of the second optical waveguide 102 and is connected to ground. The second grounding channel 106 is disposed at the other side of the second optical waveguide 102 and is connected to ground.

According to an embodiment, the first optical waveguide 101 and the second optical waveguide 102 are optically coupled to the optical input terminal and the optical output terminal in a parallel manner. In one embodiment, each of the first and second optical waveguides 101, 102 is interpreted as an arm of the optical modulator 10, as shown in FIG. 1. The coupling method may be achieved through splitting/collecting components, such as fiber optic splitters/combiners. According to an embodiment, the material of the first optical waveguide 101 and the second optical waveguide 102 may be lithium niobate (LiNbOx) crystal. Lithium niobate crystal is an ideal material for making high-performance modulators due to its excellent electro-optical effects and nonlinear optical properties. In this embodiment, selecting lithium niobate crystal as the material of the first optical waveguide 101 and the second optical waveguide 102 may increase the transmission bandwidth to 50 GHz. When a radio frequency signal is applied to the radio frequency signal channel, the phase of the optical signal in the first optical waveguide 101 changes, causing the optical signals in the first optical waveguide 101 and the second optical waveguide 102 to combine and interfere with each other, that is, the optical signal may be modulated by the radio frequency signal. Lithium niobate may provide a smaller characteristic voltage, which is beneficial to modulating optical signals through small input amplitudes. The modulated optical signal carries the information of the radio frequency signal, and this process may be regarded as a data encoding process. The modulated optical signal is then transmitted outward through the optical output terminal and the subsequently connected optical fiber, and the modulated optical signal is demodulated by the optical receiving terminal to retrieve the radio frequency signal. This process may be regarded as a data decoding process.

According to an embodiment, the radio frequency signal channels 103, 104 and the grounding channels 105, 106, 107 may be electrodes disposed extending along the first optical waveguide 101 or the second optical waveguide 102. The arrangement direction of the radio frequency signal channels 103 and 104 and the grounding channels 105, 106 and 107 may be perpendicular to the extension direction of the first optical waveguide 101 or the second optical waveguide 102. The grounding channel 107 may be optionally provided. In this embodiment, the first radio frequency signal channel 103 may be disposed at one side of the first optical waveguide 101, and the second radio frequency signal channel 104 may be disposed at the other side of the first optical waveguide 101. The first grounding channel 105 may be disposed at one side of the second optical waveguide 102, and the second grounding channel 106 may be disposed at the other side of the second optical waveguide 102. According to an embodiment, the first radio frequency signal channel 103 may be closer to the second optical waveguide 102 than the second radio frequency signal channel 104, and the second grounding channel 106 may be disposed between the second optical waveguide 102 and the first radio frequency signal channel 103. That is, the radio frequency signal channels 103 and 104 and the grounding channels 105 and 106 may be arranged in the following order: the first grounding channel 105, the second grounding channel 106, the first radio frequency signal channel 103, and the second radio frequency signal channel 104. In this embodiment, the first radio frequency signal channel 103 and the second radio frequency signal channel 104 are closer to the first optical waveguide 101 than the first grounding channel 105 and the second grounding channel 106.

According to an embodiment, the first radio frequency signal channel 103 may receive a first differential signal, and the second radio frequency signal channel 104 may receive a second differential signal, wherein the first differential signal and the second differential signal may have different phases. According to an embodiment, the phase difference between the first differential signal and the second differential signal may be within a range of 60 degrees (π/3) to 300 degrees (5π/3), so as to achieve better modulation efficiency. According to an embodiment, the first differential signal and the second differential signal may have opposite phases, that is, there may be a phase difference of π or 180 degrees between the first differential signal and the second differential signal, thereby achieving theoretically optimal modulation efficiency. It should be noted that there may be an allowable error range for the phase described above. For example, a phase difference of 170 degrees to 190 degrees between the first differential signal and the second differential signal may be equivalent to a phase difference of 180 degrees with an allowable error range of 10 degrees. In this embodiment, the optical signal in the first optical waveguide 101 is modulated by two differential signals with opposite phases in the two radio frequency signal channels 103 and 104. The optical signal in the second optical waveguide 102 is not modulated because the two grounding channels 105 and 106 are grounded. In this way, on the premise of maintaining the negative chirp modulation effect, the amplitudes of the two differential signals of the two radio frequency signal channels 103 and 104 may be effectively reduced, thus the signal crosstalk problems caused by large amplitude modulation signals may be avoided, and the transmission efficiency and stability of optical signals may also be improved.

According to an embodiment, the first differential signal and the second differential signal may have different phases (for example, the phase difference between the first differential signal and the second differential signal may be 60 degrees to 300 degrees), and may have same amplitude. In this embodiment, the optical signal in the first optical waveguide 101 is modulated by two differential signals with different phases in the two radio frequency signal channels 103 and 104, and the optical signal in the second optical waveguide 102 is not modulated because the two grounding channels 105 and 106 are grounded. In this way, on the premise of maintaining the negative chirp modulation effect, the amplitudes of the two differential signals of the two radio frequency signal channels 103 and 104 may be effectively reduced, thus the signal crosstalk problems caused by large amplitude modulation signals may be avoided, and the transmission efficiency and stability of optical signals may also be improved.

According to an embodiment, the first differential signal and the second differential signal may have opposite phases and may have the same amplitude. In this embodiment, the optical signal in the first optical waveguide 101 is modulated by two differential signals with different phases in the two radio frequency signal channels 103 and 104, and the optical signal in the second optical waveguide 102 is not modulated because the two grounding channels 105 and 106 are grounded. In this way, on the premise of maintaining the negative chirp modulation effect, the amplitude of the two differential signals of the two radio frequency signal channels 103 and 104 may be reduced to half of the amplitude of the general dual-arm modulation structure, thus the signal crosstalk problems caused by large amplitude modulation signals may be avoided, and the transmission efficiency and stability of optical signals may also be improved. Also, modulation with a smaller amplitude may reduce power consumption and realize low-cost as well as long-distance transmission.

According to one embodiment, the optical modulator 10 may optionally include a first thermal electrode 108. The first thermal electrode 108 is disposed at the first optical waveguide 101 and disposed between the first radio frequency signal channel 103 or the second radio frequency signal channel 104 and the optical output terminal. In this embodiment, the first thermal electrode 108 may be configured to receive a DC voltage to heat the first optical waveguide 101. Based on the sensitivity of the optical properties (e.g., refractive index) of the material of the first optical waveguide 101 to temperature, as the voltage is applied to the first thermal electrode 108 inducing the temperature rises, a phase difference between the optical signals of the first optical waveguide 101 and the second optical waveguide 102 may be generated, thereby causing the output optical power of the output terminal after the first optical waveguide 101 and the second optical waveguide 102 combines to change.

In the embodiment described above, the optical modulator 10 may also optionally include a second thermal electrode 109 in addition to the first thermal electrode 108. The second thermal electrode 109 is disposed at the second optical waveguide 102 and disposed between the first grounding channel 105 or the second grounding channel 106 and the optical output terminal. In this embodiment, the second thermal electrode 109 may be configured to receive a DC voltage to heat the second optical waveguide 102. Based on the sensitivity of the optical properties (e.g., refractive index) of the material of the second optical waveguide 102 to temperature, as the voltage is applied to the second thermal electrode 109 inducing the temperature rises, a phase difference between the optical signals of the first optical waveguide 101 and the second optical waveguide 102 may be generated, thereby causing the output optical power of the output terminal after the first optical waveguide 101 and the second optical waveguide 102 combines to change.

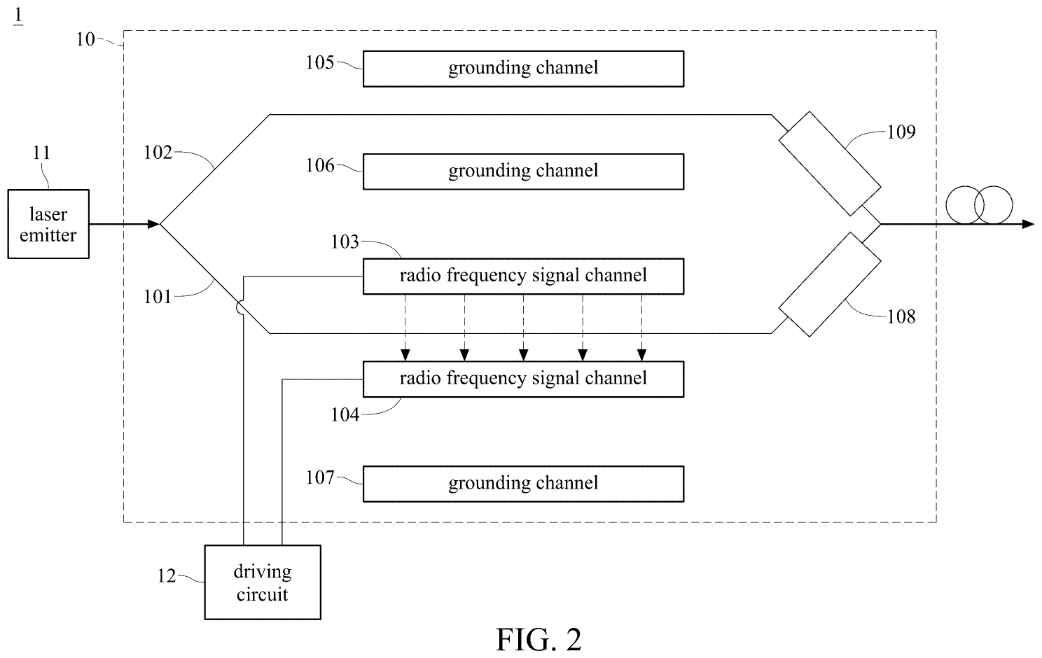

Please refer to FIG. 2 which is a block diagram of an optical transmission system according to an embodiment of the present disclosure. As shown in FIG. 2, an optical transmission system 1 includes an optical modulator 10, a laser emitter 11 and a driving circuit 12. The optical modulator 10 includes a first optical waveguide 101, a second optical waveguide 102, a first radio frequency signal channel 103, a second radio frequency signal channel 104, a first grounding channel 105 and a second grounding channel 106. The second optical waveguide 102 and the first optical waveguide 101 are optically coupled to an optical input terminal and an optical output terminal, wherein the optical input terminal is optically coupled to the laser emitter 11. The first radio frequency signal channel 103 is disposed at one side of the first optical waveguide 101. The second radio frequency signal channel 104 is disposed at the other side of the first optical waveguide 101. The first grounding channel 105 is disposed at one side of the second optical waveguide 102 and is connected to ground. The second grounding channel 106 is disposed at the other side of the second optical waveguide 102 and is connected to ground. The driving circuit 12 is electrically connected to the first radio frequency signal channel 103 and the second radio frequency signal channel 104, and is configured to provide a first differential signal to the first radio frequency signal channel 103, and provide a second differential signal to the second radio frequency signal channel 104, wherein the first differential signal and the second differential signal have different phases.

In this embodiment, the structure of the optical modulator 10 is basically the same as that of the embodiment in FIG. 1, and repeated description is omitted herein. According to an embodiment, the laser emitter 11 may emit a continuous wave optical signal or a pulse optical signal. That is, the laser emitter 11 may be a continuous wave laser (CW laser) or a pulse laser. According to an embodiment, the two differential signals applied to the radio frequency signal channels 103 and 104 may be provided by the driving circuit 12. According to an embodiment, the driving circuit 12 may determine the voltage values of the first differential signal and the second differential signal according to the transmission distance of the optical signal. For example, the greater the voltage values of the first differential signal and the second differential signal, the more dispersion compensation values can be generated, which may correspond to longer transmission distance. In one embodiment, as the transmission distance increases, the driving circuit 12 may determine that the voltage values of the first differential signal and the second differential signal to be greater, so as to generate more dispersion compensation values.

The settings of the first differential voltage and the second differential voltage described above may be realized through the microcontroller of the driving circuit 12 itself, or may be generated through human operation settings. In one embodiment, the driving circuit 12 may include one or more processing/control units with data receiving, recording, computing, storage and output functions. The processing/control unit is, for example, a microcontroller, a central processing unit, a graphics processor, a programmable logic controller, or any combination of the above.

In view of the above description, according to one or more embodiment of the present disclosure, the optical modulator and optical transmission system, in terms of configuration, the two radio frequency signal channels are disposed at one arm of the optical modulator and the two grounding channels are disposed at another arm of the optical modulator, and the two differential signals with different phases are applied to the two radio frequency signal channels respectively, thereby forming a single-arm small amplitude modulation structure. In this way, compared with the traditional dual-arm modulation, the signal amplitude required for modulation may be effectively reduced and the signal crosstalk problem caused by the large amplitude modulation signal may be avoided, and the transmission efficiency and stability of optical signals are also improved. The present disclosure is particularly applicable for high-speed, long-distance optical fiber communication systems.

What is claimed is:

1. An optical modulator, comprising:
a first optical waveguide;
a second optical waveguide optically coupled to an optical input terminal and an optical output terminal with the first optical waveguide;
a first radio frequency signal channel disposed at one side of the first optical waveguide and configured to receive a first differential signal;
a second radio frequency signal channel disposed at another side of the first optical waveguide and configured to receive a second differential signal, wherein the first differential signal and the second differential signal have different phases;
a first grounding channel disposed at one side of the second optical waveguide and connected to ground; and
a second grounding channel disposed at another side of the second optical waveguide and connected to ground.

2. The optical modulator of claim 1, wherein a phase difference between the first differential signal and the second differential signal is within a range of 60 degrees to 300 degrees.

3. The optical modulator of claim 2, wherein the first differential signal and the second differential signal have opposite phases.

4. The optical modulator of claim 1, wherein the first differential signal and the second differential signal have a same amplitude.

5. The optical modulator of claim 1, wherein the first radio frequency signal channel is closer to the second optical waveguide than the second radio frequency signal channel, and the second grounding channel is disposed between the second optical waveguide and the first radio frequency signal channel.

6. The optical modulator of claim 1, wherein a material of the first optical waveguide and the second optical waveguide is lithium niobate crystal.

7. The optical modulator of claim 1, further comprising:
a first thermal electrode disposed at the first optical waveguide and disposed between the first radio frequency signal channel or the second radio frequency signal channel and the optical output terminal; and
a second thermal electrode disposed at the second optical waveguide and disposed between the first grounding channel or the second grounding channel and the optical output terminal.

8. An optical transmission system, comprising:
a laser emitter;
an optical modulator, comprising:
a first optical waveguide;
a second optical waveguide optically coupled to an optical input terminal and an optical output terminal with the first optical waveguide, wherein the optical input terminal is optically coupled to the laser emitter;
a first radio frequency signal channel disposed at one side of the first optical waveguide;
a second radio frequency signal channel disposed at another side of the first optical waveguide;
a first grounding channel disposed at one side of the second optical waveguide and connected to ground; and
a second grounding channel disposed at another side of the second optical waveguide and connected to ground; and
a driving circuit electrically connected to the first radio frequency signal channel and the second radio frequency signal channel, and configured to provide a first differential signal to the first radio frequency signal channel and provide a second differential signal to the second radio frequency signal channel, wherein the first differential signal and the second differential signal have different phases.

9. The optical transmission system of claim 8, wherein a phase difference between the first differential signal and the second differential signal is within a range of 60 degrees to 300 degrees.

10. The optical transmission system of claim 9, wherein the first differential signal and the second differential signal have opposite phases.

11. The optical transmission system of claim 8, wherein the first differential signal and the second differential signal have a same amplitude.

12. The optical transmission system of claim 8, wherein the first radio frequency signal channel is closer to the second optical waveguide than the second radio frequency signal channel, and the second grounding channel is disposed between the second optical waveguide and the first radio frequency signal channel.

13. The optical transmission system of claim 8, wherein a material of the first optical waveguide and the second optical waveguide is lithium niobate crystal.

14. The optical transmission system of claim 8, wherein the optical modulator further comprises:
a first thermal electrode disposed at the first optical waveguide and disposed between the first radio frequency signal channel or the second radio frequency signal channel and the optical output terminal; and
a second thermal electrode disposed at the second optical waveguide and disposed between the first grounding channel or the second grounding channel and the optical output terminal.
